(19) United States
(12) Patent Application Publication
(10) Pub. No.: US 2005/0138095 A1
(43) Pub. Date: Jun. 23, 2005

(54) Method for base two logarithmic estimation

(75) Inventors: Gordon Clyde Fossum, Austin, TX (US); Stephen Joseph Schwinn, Lakeville, MN (US); Matthew Ray Tubbs, Rochester, MN (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/739,427

(22) Filed: Dec. 18, 2003

(51) Int. Cl. G06F 1/02

(52) U.S. Cl. 708/277

(57) ABSTRACT

The present invention provides for implementing a base two logarithmic estimation function in a general purpose processor. The present invention provides for partitioning an input value into a biased exponent value and a mantissa. Whether the biased exponent value is negative is determined. A first intermediate value from the mantissa is generated using custom combinational logic. A second intermediate value from the mantissa is generated using custom combinational logic. An unnormalized result fraction value from the first and second intermediate value and the mantissa is generated using custom combinational logic. This unnormalized result fraction and the unbiased exponent of the input are concatenated and normalized to form the final result.

### TECHNICAL FIELD

The present invention relates generally to a numerical estimation for use with data processing, and more particularly to performing a logarithmic numerical estimation for use with data processing.

### BACKGROUND

A general purpose processor typically cannot perform a logarithmic function as efficiently as other mathematical operations, such as addition, subtraction, and multiplication. A logarithmic function is likely to require many more processor cycles than a multiplication operation, for example.

According to the format specified by IEEE Standard 754 for Binary Floating Point Arithmetic, a normalized floating-point number, such as x, is represented by three groups of bits, namely, a sign bit, exponent bits, and mantissa bits. The sign bit is the most significant bit of the floating-point number. The next eight less significant bits are the exponent bits, which represent the signed biased exponent of the floating-point number. An unbiased exponent can be computed by subtracting the appropriate bias from the biased exponent. Furthermore, there are different biases for different floating point representations. Those of skill in the art understand that IEEE 754 is just one example of the type of numerical representations usable.

The 23 least significant bits are the fraction bits, where the value of the significand, here referred to as the mantissa, is computed by dividing the unsigned integral value represented by these 23 bits by 2² and adding 1 to the quotient. Although the number 23 above is used for single-precision floating point calculations, those of skill in the art understand that other counts of fraction bits can be used with other appropriate precisions.

Excluding the sign bit, a floating-point number x can be considered as a product of two parts corresponding to the exponent and the mantissa, respectively. The part corresponding to the exponent of x has the value 2^{exp}, where exp is the unbiased exponent. Thus, log₂(x) can be expressed by the sum of the logs of the above two parts (that is, log₂ 2^{exp}+log₂ (mantissa)). The log₂(2^{exp}) is the unbiased exponent, exp, itself, which is a signed integer. Thus log₂(mantissa) is the positive fractional part of the floating-point result yF, because the value of the mantissa is between 1 (inclusive) and 2, therefore the value of yF is between 0 (inclusive) and 1, where yF=log₂ (mantissa). Thus, the floating-point result y can be obtained as follows:
y=exp+log₂(mantissa)
where exp is the unbiased exponent of x, and mantissa is the mantissa of x.

If a graph of the log₂(mantissa) function is compared with a graph of a linear function (mantissa-1) within the range of 1 to 2 for the mantissa, the results from the above two functions are identical at the endpoints, while the results from the log₂(mantissa) function is typically slightly greater than the results from the linear function between the endpoints.

Conventionally, if a logarithmic function with a low-precision estimation is needed, then the low-precision logarithmic function can be obtained simply by making small corrections to the linear function. On the other hand, if a logarithmic function with a higher precision estimation is required, the higher-precision logarithmic function can be obtained by means of a table lookup, sometimes in conjunction with point interpolation, as is well-known to those skilled in the art.

A floating-point number x, in the IEEE 754 format for example, is partitioned into a signed biased exponent part, exp_{bias}, and a fraction part, xF. An unbiased exponent, exp, is then obtained, such as by subtracting 127 or other appropriate value from the biased exponent. Next, an unnormalized mantissa is then obtained via a lookup table utilizing fraction part xF as the input.

If the biased exponent part is negative, both the unbiased exponent and the unnormalized mantissa will be complemented. The unbiased exponent is then concatenated with the unnormalized mantissa, with a binary point in between to form an immediate result. Subsequently, the immediate result is normalized by removing all leading zeros and the leading one, such as via left shifting, to obtain an normalized fraction part of the result y, and the exponent part of the result y is then generated by, for example, counting the number of leading digits shifted off and then subtracting that number from 8, or another number, as appropriate to the precision. At this point, the exponent part of the result y is unbiased. Finally, the floating-point result y is formed by combining the unbiased exponent part and the normalized faction part. A biased exponent can be obtained by adding 127 to the unbiased exponent.

However, there are problems associated with the above approach. For instance, employment of a look-up table with estimations can add to the complexity of the circuitry, thereby adding to the power consumption and cycle time for the calculations. This can be especially irksome in real-time graphics calculations, as both power consumption and completion time for the value estimation can be critical limiting factors.

For instance, conventional technologies with discontinuities and lack of accuracy could be egregious enough that various software developers refuse to use it. Software developers may have used slower software lookup tables or other methods, in certain games, rather than using the hardware estimations.

Therefore, there is a need for an improved estimation of numerical values in a manner that addresses at least some of the problems associated with conventional technological approaches to the estimations of numerical values.

### SUMMARY OF THE INVENTION

The present invention provides for determining a floating point estimation of a number. Combinational logic is configured to produce a first value and a second value from an original value. A first adder is configured to accept the first values, wherein the adder is further configured to add the accepted first value to the original value. A second adder is configured to accept an output of the first adder and the combinational logic.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a prior art base two logarithmic estimation graph with discontinuities;

FIG. 2 schematically depicts a fraction section of a logarithmic estimator;

FIG. 3A illustrates a method for calculating an input value into an estimated logarithmic value;

FIG. 3B illustrates an example of estimating a logarithmic value for the inputted value of fifty-four;

FIG. 4 illustrates an example of a continuity of a base 2 logarithm calculated using the system of FIG. 2; and

FIG. 5A illustrates a sphere rendered with conventional logarithmic estimation processes; and

FIG. 5B illustrates a sphere rendered with the logarithmic estimation process of FIG. 2

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, digital logic design techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

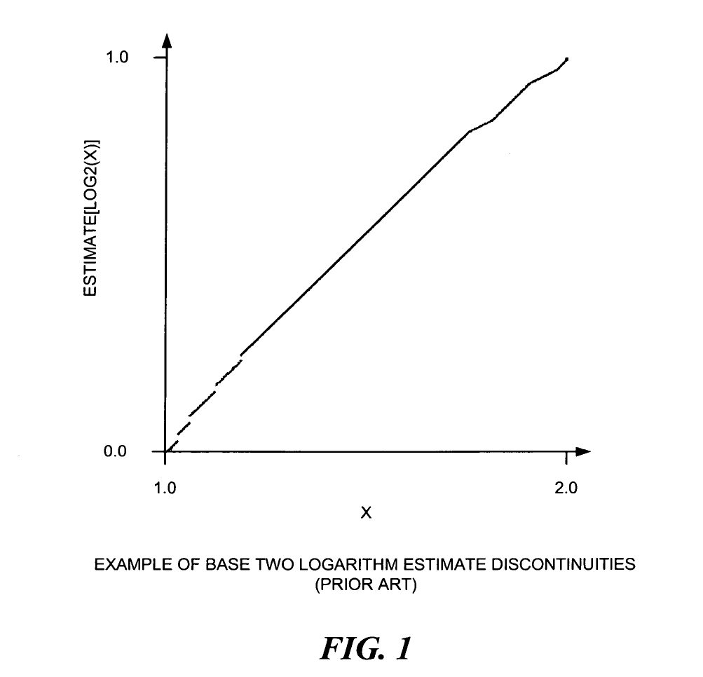

Turning to FIG. 1, disclosed is a representation of a conventional logarithmic estimation when calculating in logarithm two. As is illustrated, there are discontinuities when calculating the logarithm value. When used with rendering techniques, this can create substantial incongruities in the graphical rendering process.

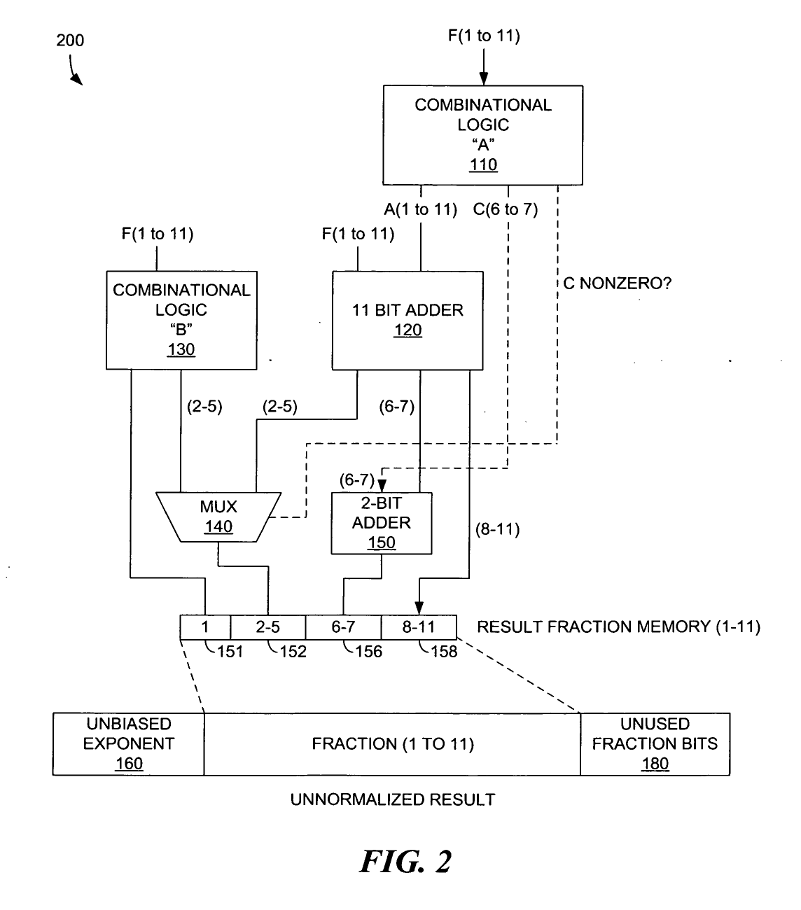

Turning to FIG. 2, illustrated is a logarithmic estimator 200. The value to be logarithmically estimated (such as the value 54) is divided into a fraction part (F), a biased exponent part, and a sign part before getting to the system 200. The fraction part (F) of the value to be estimated is received in logic block A 110. In one embodiment, the fractional bits are bits from 1 to 11. The combinational logic block A 110 a produces not one, but two values, which for ease of illustration are called A and C. Bits 1-11 of the A output is input into an adder (an “11 bit adder”,) 120, and summed with F1 to 11. The output of the 11-bit adder 120 is then broken up into various bits. Bits 6 to 7 of the sum of A and F are then output into a 2-bit adder 150, and added to bits 6 and 7 of the C value which is calculated in combinational logic A 110, and then stored in an unnormalized result memory 156. Bits 8 to 11 are output from the 11-bit adder to a results fraction memory 158 for bits 8 to 11.

In the system 200, the logarithmic value is still broken into a sign bit, a biased exponent and a fraction value (F). However, when generating the value to be added to the original fraction value by the combinational logic A 110, two numbers are generated, not just one. This creates significantly less discontinuity in the production of estimated logarithmic values.

Generally, combinational logic block A 110 takes as inputs the 11 most significant bits of the fraction part of the input. It produces two outputs, referred to as A and C. The combinational logic is designed such that as the value of the input fraction F increases, the sum of the values of A and C will be largest near the midpoint of the entire range of F (0000000000 to 1111111111). The sum of A and C will be the smallest (0) at the two endpoints. This allows the characteristic bowed out curve of a logarithmic function. The added accuracy and continuity of this algorithm is added without substantially diminishing performance as defined in clock speed. This is at least in part because of the A and C output configuration. The logic configuration of block A is more streamlined compared to a configuration wherein only one addend is produced. This is in part because portions of the logic to produce A and C only needs to be produced once, whereas that same logic involved in producing a single addend would need to be reproduced several times, diminishing performance of that logic 110. Also, some of the logical effort is essentially moved from determining a single addend to the logic that implements the three-way adder, which is blocks 120, 130, 140 and 150 combined. This streamlining also allows this design to be implanted without substantially diminishing performance when compared to conventional technologies. Separating logic into producing separate A and C values also allows some flexibility in implementation, since logic can be more easily moved across cycle boundaries.

Combinational logic block B 130 is also illustrated. Combinatorial logic block B 130 passes the leading fraction bit to be placed within the first memory block 151 of the results fraction. A MUX 140 accepts input for bits 2-5 from both the 11-bit adder and the combinatorial logic block B 130. The output of the MUX 140 is selected as a function of the combinatorial logic block A, which generates a signal which indicates whether on not the C value is a non-zero value. If C is a zero number, then the MUX uses the output of the 11 bit adder. However, if C is a non-zero number, the MUX uses the output of the combinational logic B.

However, those of skill in the art understand that the A and C outputs and the input mantissa can be added within a single adder, instead of the combination of boxes 120, 130, 140 and 150 in FIG. 2. In one embodiment, the two adders 120 and 150, the MUX 140 and the combinational logic B 130 are implemented in a 3-way adder. Alternatively, some other integral combination of the functions of boxes 120, 130, 140 and 150 could be used.

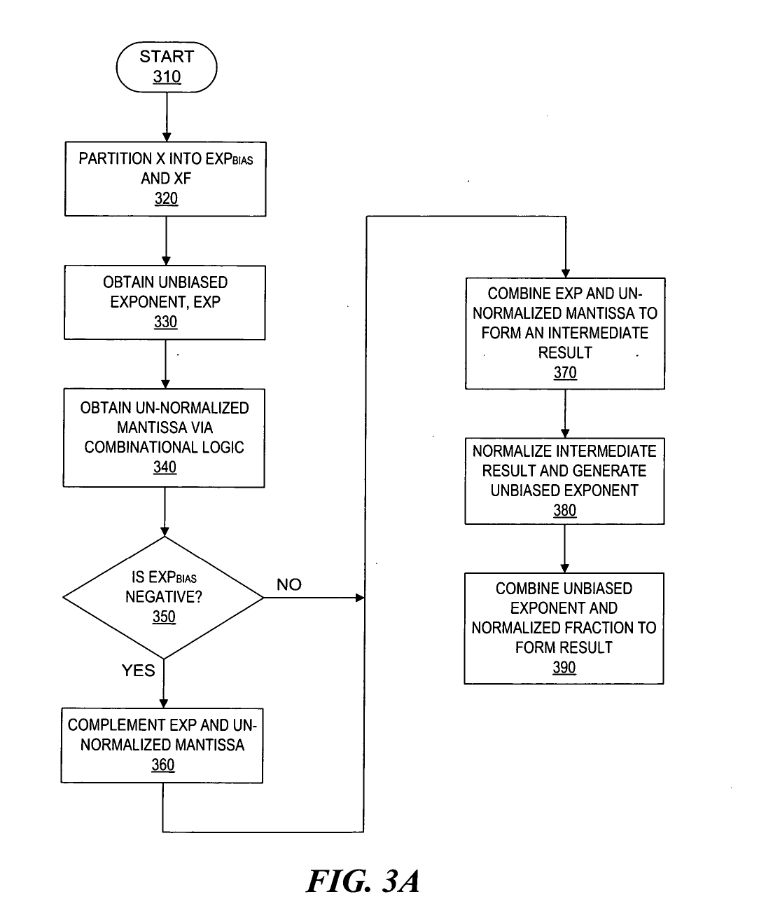

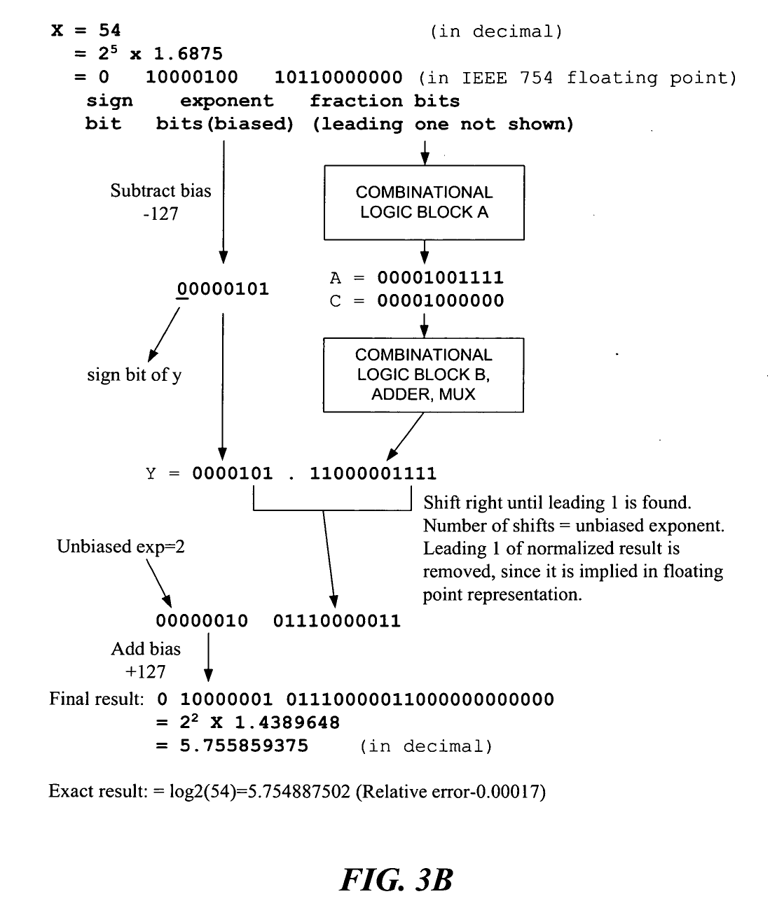

FIG. 3A illustrates a method of use of the system 100. After start step 310, the input is partitioned into a biased exponent and a floating point in step 320. In step 330, an unbiased exponent is calculated and a floating point is calculated. In step 340, an unnormalized mantissa is generated, such as shown in FIG. 2, via the combinational logic of block A, block B, the 11 and 2 bit adder, and so on. In step 350, it is determined whether the original exponent of the number to be calculated is negative. If it is, in step 360, both the exponent and the unnormalized mantissa are complemented. In any event, in step 370, both the unnormalized mantissa, the exponent, and the mantissa are normalized to form an intermediate result. Then in step 380, the intermediate result is “normalized” and the shift right occurs to generate an unbiased exponent. Finally, in step 390, the unbiased exponent and the normalized fraction are combined to form the final answer in IEEE 754 single-precision format.

FIG. 3B illustrates an example of the use of the method of FIG. 3A. After start step 310, in step 320 a value 54 is partitioned into a sign bit of 0 due to X being a positive number, 2⁵ the exponent value, and 1.6875 is the fraction bit. In step 330, the unbiased exponent bits are generated by subtracting a bias of 127 (in binary 1111111) from the binary complement expression of “5”, 1000100.

In step 340, the unnormalized mantissa is generated through combinatorial logic. The floating point, expressed as 10110000000 is input into combinational logic A, thereby generating the values A=00001001111 and C=00001000000.These values are then combined as illustrated in FIG. 1 to generate the unnormalized result of 11000001111.

In step 350, in FIG. 3B, it is determined that the unbiased exponent is positive. Therefore, the unbiased exponent and the unnormalized mantissa are concatenated. Then in step 380, the right shift of 101.11000001111 is performed until the leading one is found, and since it takes two shifts to move the decimal point to just to the right of the number, then the result will have an unbiased exponent value of two. In step 390, the unbiased exponent and the normalized fraction are combined, such as creating 5.755859375 value for the logarithm.

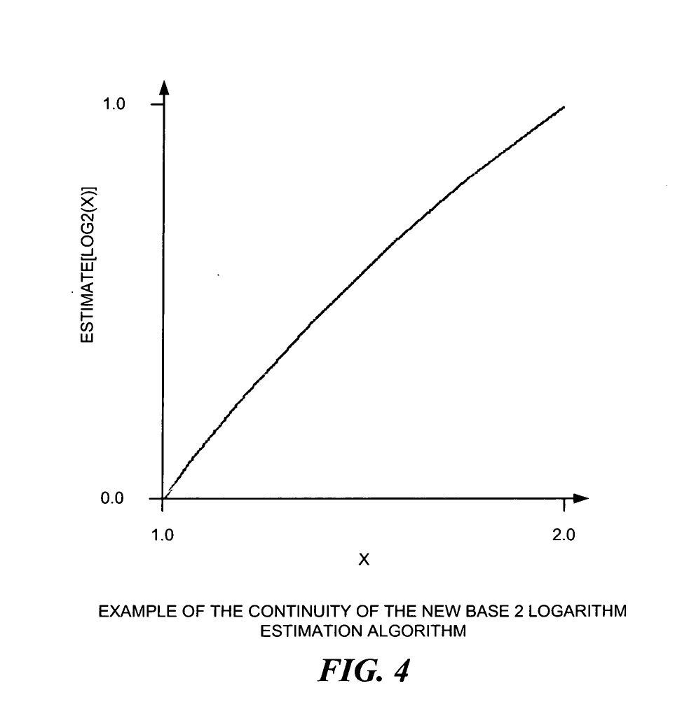

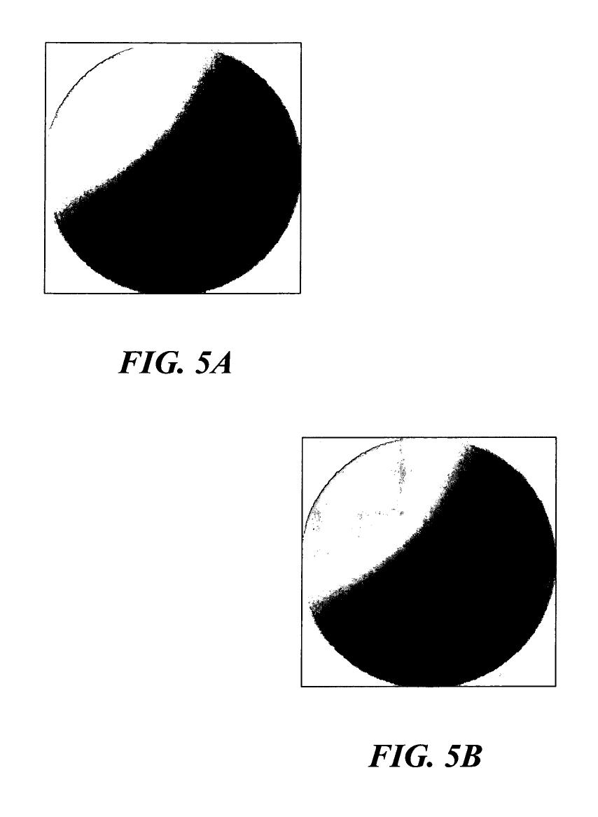

FIG. 4 illustrates an example of logarithmic estimation using the present method for determining logarithms. FIG. 5A illustrates a rendition of a ball with specular highlight (simulation of the reflection of a light source) in the upper left corner of the figure in the prior art. FIG. 5B illustrates a rendition of a ball and specular highlight after the highlight is calculated by using the present invention. FIG. 5B has less discontinuities than FIG. 5A.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for determining logarithmic floating point estimation of a number, comprising:
a combinational logic configured to produce a first value and a second value from an original value;
a first adder configured to accept the first value, the adder further configured to add the accepted first value to the original value; and
a second adder configured to accept an output of the first adder and the combinational logic.

2. The system of claim 1, further comprising a multiplexer coupled to the first adder.

3. The system of claim 2, further comprising a second combinational logic coupled to the multiplexer.

4. The system of claim 1, further comprising a memory coupled to the output of the first combination logic.

5. The system of claim 3, wherein the second combinational logic is coupled to the memory.

6. The system of claim 3, wherein the output of the multiplexer is coupled to the memory.

7. The system of claim 1, further comprising a memory coupled to the output of the second adder.

8. A method for estimating a logarithmic value, comprising:
partitioning an input value into a biased exponent value and a mantissa value;
determining whether the unbiased exponent value is negative;
generating a first intermediate value from the mantissa value;
generating a second intermediate value from the mantissa value; and
generating an unnormalized result fraction value from the first and second intermediate value and the mantissa value.

9. The method of claim 8, wherein the unbiased exponent value is negative, complementing the unbiased negative value and complementing the unnormalized mantissa value.

10. The method of claim 8, further comprising deriving a sign bit of the input value.

11. The method of claim 10, further comprising:
unbiasing the biased exponent value; and
normalizing the unbiased exponent value and the unnormalized mantissa result value.

12. The method of claim 11, further comprising concatenating the sign bit, the unbiased exponent value, and the unnormalized mantissa value.

13. A system for for determining logarithmic floating point estimation of a number, comprising:
a combinational logic configured to produce a first value and a second value from an original value; and
an adder configured to accept the first value, the adder further configured to add the accepted first value to the original value wherein the adder is further configured to combine the addition of the accepted first value and the original value with the output of the combinational logic.

14. A computer program product for estimating a logarithmic value, the computer program product having a medium with a computer program embodied thereon, the computer program comprising:
computer code for partitioning an input value into a biased exponent value and a mantissa value;
computer code for determining whether the unbiased exponent value is negative;
computer code for generating a first intermediate value from the mantissa value;
computer code for generating a second intermediate value from the mantissa value; and
computer code for generating an unnormalized result fraction.

15. A processor for estimating a logarithmic value, the processor including a computer program comprising:
computer code for partitioning an input value into a biased exponent value and a mantissa value;
computer code for determining whether the unbiased exponent value is negative;
computer code for generating a first intermediate value from the mantissa value;
computer code for generating a second intermediate value from the mantissa value; and
computer code for generating an unnormalized result fraction.
